(19) United States
(12) Patent Application Publication
(10) Pub. No.: US 2023/0060204 A1
(43) Pub. Date: Mar. 2, 2023

(54) GENERATING TRAINING DATA FOR MACHINE LEARNING MODEL FOR SECONDARY OBJECT RECOMMENDATIONS

(71) Applicant: Tekion Corp, Pleasanton, CA (US)

(72) Inventors: Jayaprakash Vijayan, Dublin, CA (US); Ved Surtani, Bengaluru (IN); Nitika Gupta, Bengaluru (IN); Pratheek Manjunath Bharadwaj, Mysore (IN)

(21) Appl. No.: 17/459,662

(22) Filed: Aug. 27, 2021

(51) Int. Cl. G06Q 30/02; G06K 9/62; G06N 20/00

(52) U.S. Cl. CPC G06Q 30/0282; G06Q 30/0203; G06K 9/6257; G06N 20/00

(57) ABSTRACT

A management system of a plurality of entities generates secondary object recommendations for primary objects being acquired from the entities. The management system generates training data by classifying historical acquisition entries from the entities that describe acquisitions of primary objects and secondary objects with predetermined secondary object classifications. The generated training data is used to train a machine learning model to predict for each predetermined secondary object classification a likelihood of selection of a secondary object associated with the predetermined secondary object classification. Responsive to a primary object being acquired from any one of the plurality of entities, the management system may generate a recommendation for one or more secondary objects to provide with the primary object.

### BACKGROUND

### Field of Disclosure

The present disclosure generally relates to a management system of a plurality of entities, and more specifically to a management system that generates training data for a machine learning model and training the machine learning model to generate recommendations of secondary objects to recommend during an acquisition of a primary object using the generated training data.

### Description of the Related Art

Entities provide primary objects such as automobiles to users. While providing the primary objects, the entities may recommend secondary objects (e.g., insurance packages) in addition to the primary objects. The entities receive the secondary objects from a plurality of different third party secondary object sources that operate in conjunction with the entities. Although the different third party secondary object sources may provide similar types of secondary objects, third party secondary object sources each may have their own unique identifiers for the secondary objects. Thus, conventional management systems have to be uniquely configured for each entity to provide recommendations for secondary objects that are in accordance with the identifiers of the secondary objects that are specific to the third party secondary object source that provide the secondary objects to the entity.

### SUMMARY

A management system for a plurality of different entities that provide primary objects and secondary objects to clients of the entities is disclosed. In one embodiment, each entity has a preferred set of secondary object sources from which the entity receives secondary objects. The secondary object sources each provide similar types of secondary objects to the different entities where each secondary object has an identifier that is unique to the secondary object source that provides the secondary object.

The management system performs identifier standardization of different secondary objects provided by the plurality of different secondary object sources by classifying the secondary objects into one or more predetermined secondary object classifications. By applying the predetermined secondary object classifications to the secondary objects provided by the different secondary object sources, the management system is able to provide secondary object recommendations for the plurality of different entities.

In one embodiment, the management system accesses historical acquisition entries from the plurality of entities where each entry describes a user acquisition of a primary object and at least one secondary object from an entity. The management system classifies each historical acquisition entry with one or more of the predetermined secondary object classifications to standardize an identifier of the secondary object described in the entry thereby generating training data.

In one embodiment, the management system trains a machine learning model using the generated training data. The training data includes features from the historical acquisition entries such as the predetermined secondary object classification assigned to each entry as well as the attributes of the primary object included in each entry. Once the machine learning model is trained, the machine learning model is deployed to provide recommendations of secondary objects when a primary object is being acquired.

During deployment, the machine learning model receives attributes of a primary object being acquired from an entity from the plurality of different entities. The attributes of the primary object are applied to the trained machined learning model which generates for each of the plurality of predetermined secondary object classifications a predicted likelihood of selection of a secondary object associated with the predetermined secondary object classification. The management system identifies the entity's preferred secondary object source and determines secondary objects provided by the preferred secondary object source that corresponds to at least a highest ranked secondary object classification based on the predicted likelihoods.

### BRIEF DESCRIPTION OF DRAWINGS

FIG. 1 is a high-level block diagram illustrating an embodiment of an environment for providing customized recommendations of secondary objects for primary objects, according to one embodiment.

FIG. 2 is a high-level block diagram illustrating a detailed view of a management system, according to one embodiment.

FIG. 3A illustrates an example set of historical acquisition entries, according to one embodiment.

FIG. 3B illustrates an example set of training data generated based on the historical action entries, according to one embodiment.

FIG. 4 illustrates an example process of generating training data to train a prediction module, according to one embodiment.

FIG. 5 illustrates an example process of generating recommendations of a secondary objects for a primary object using the trained prediction module, according to one embodiment.

FIG. 6 is system diagram of a computer system, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

### Management System Environment

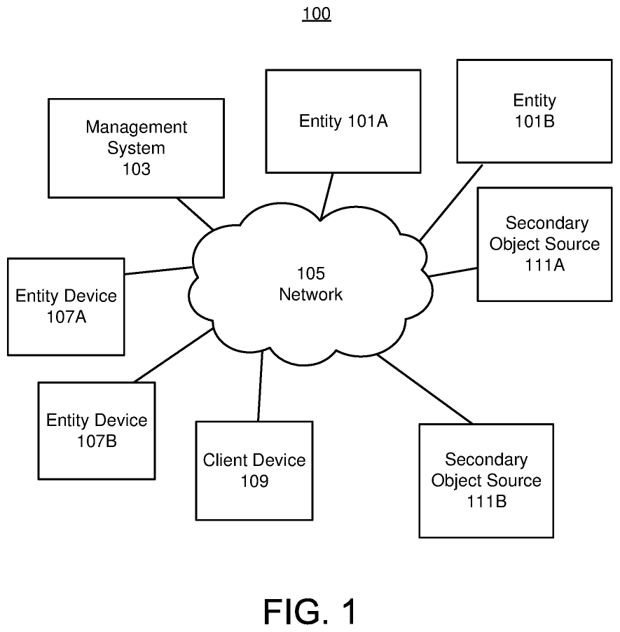

FIG. 1 is a high-level block diagram illustrating an embodiment of an environment 100 of a management system 103 for generating recommendations of secondary objects for primary objects provided by a plurality of different entities 101. An example of an entity 101 included in the environment 100 is an automobile dealership. In the example of an automobile dealership, the primary object may be an automobile provided by the automobile dealership and a secondary object may be a finance product and/or insurance product for the automobile. However, the entity 101 can be any type of entity that requires secondary object recommendation for primary objects provided by the entity 101.

In one embodiment, the environment 100 includes management system 103, a plurality of entities 101A and 101B, a plurality of secondary object sources 111A and 111B, a plurality of entity devices 107A and 107B, and at least one client device 109 connected to each other via a network 105. As shown in FIG. 1, the management system 103 is separate from the entities 101A and 10B. Note that in another embodiment, instances of the management system may be included in each entity 101. Any number of management systems, entities, enterprise devices, secondary object sources and client devices may be present in other embodiments.

The network 105 provides a communication infrastructure between the entities included in environment 100. The network 105 is typically the Internet, but may be any network, including but not limited to a Local Area Network (LAN), a Metropolitan Area Network (MAN), a Wide Area Network (WAN), a mobile wired or wireless network, a private network, or a virtual private network.

Entity devices 107 and client devices 109 may include any type of device having an application that communicates with the management system 103 and entities 101. In one embodiment, the application may be a dedicated application specifically designed by the organization associated with the management system 103. Examples of the entity devices and client devices 109 include a mobile device or personal computer or any other type of device.

Generally, an entity device 107 represent a device of a corresponding entity 101. For example, entity device 107A represents a device of entity 101A whereas entity device 107B represents a device of entity 101B. Representatives of the entity 101 use entity devices 107 to communicate with the entity 101 and/or the management system 103. For example, a representative of entity 101A may use entity device 107A to generate a request for the management system 103 to generate recommendations of secondary objects for a primary object during a user acquisition of a primary object from the entity 101A. In contrast, a client device 109 represents devices of non-representatives of the entity 101. An example of a non-representative of the entity 101 is a client of the entity 101.

In one embodiment, the environment 100 includes a plurality of secondary object sources 111A and 111B. The secondary object sources 111A and 111B are independent from each other. In one embodiment, each secondary object source 111A and 111B is a third-party provider of a plurality of different types of secondary objects to entities 101A and 101B. In one embodiment, the secondary object sources 111A and 111B provide the same types of secondary objects for primary objects. However, the secondary object sources 111A and 111B each have their own name and internal identifiers for the secondary objects. Each secondary object source 111 may provide secondary objects to one or more of the entities 101A and 101B. For example, secondary object source 111A may provide secondary objects to both entity 101A and 101B whereas secondary object source 111B may provide secondary objects to entity 101A but not entity 101B.

In one embodiment, the different types of secondary objects are classified as either finance objects or insurance objects for automobiles (e.g., the primary object). Examples of a finance object for an automobile is a vehicle service contract (e.g., an extended warranty) that covers repair costs for certain components of the automobile after the entity or manufacturer's warranty for the automobile expires, and a service package that covers scheduled automobile services for a predetermined amount of time. Examples of an insurance object includes gap insurance which is an optional insurance to complete a balance of a loan for the automobile if the automobile is stolen, accidental health insurance is optional health insurance that covers benefits for accidental injuries, tire and wheel insurance is optional insurance to cover repair of tire and wheels of the automobile due to road hazards, and appearance protection insurance is optional insurance to cover repairs to an exterior and interior of the vehicle. Other types of secondary objects may be provided dependent on type of primary object. In one embodiment, each secondary object has at least a cost for the secondary object, a description of the benefits of the secondary objects, and a time duration of validity of the secondary object.

The management system 103 is configured to generate for each entity 101 customized recommendations of secondary objects for primary objects. The management system 103 may generate the recommendation for one or more secondary objects for a primary object during user acquisition of the primary object from an entity 101. For example, the management system 101 may recommend one or more finance and insurance objects to recommend to a user that is acquiring an automobile from an automobile dealership.

### Management System

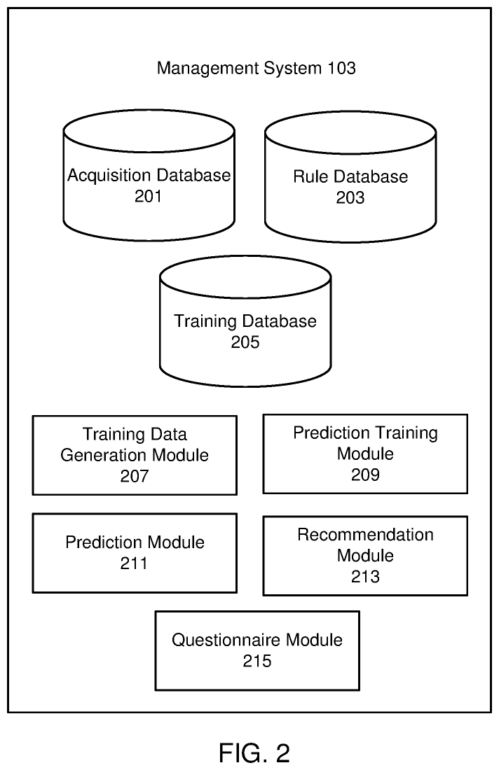

FIG. 2 is a high-level block diagram illustrating a detailed view of the management system 103 of FIG. 1. In one embodiment, the management system 103 includes an acquisition database 201, a rule database 203, a training database 205, a training data generation module 207, a prediction training module 209, a prediction module 211, a recommendation module 213, and a questionnaire module 215. Note that in other embodiments, the document management system 103 may include other modules and/or databases than those illustrated in FIG. 2.

The acquisition database 201 is configured to store a plurality of acquisition entries. In one embodiment, the acquisition entries describe historical user acquisitions of primary objects and secondary objects from the different entities 101A and 101B. Each acquisition entry describes a user acquisition of a primary object in addition to one or more secondary objects for the primary object.

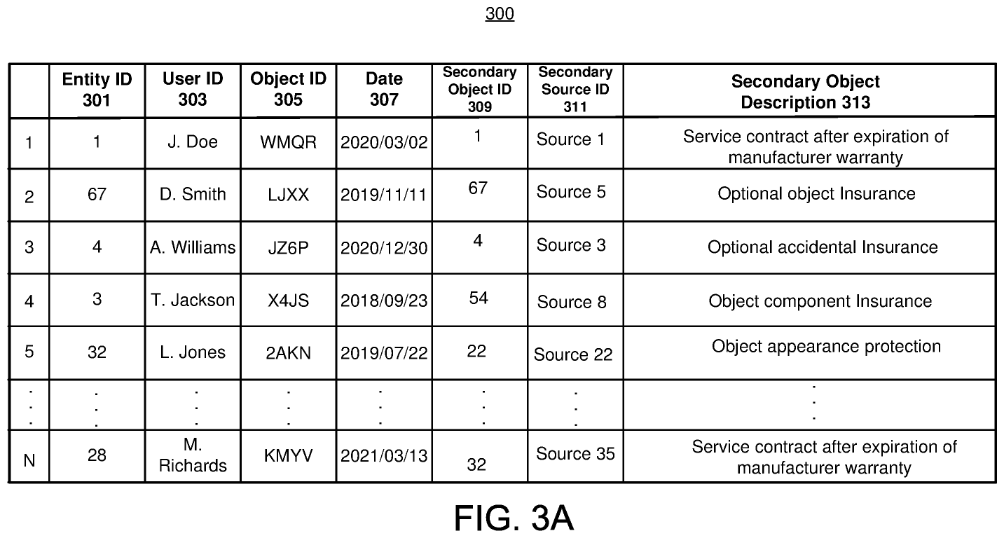

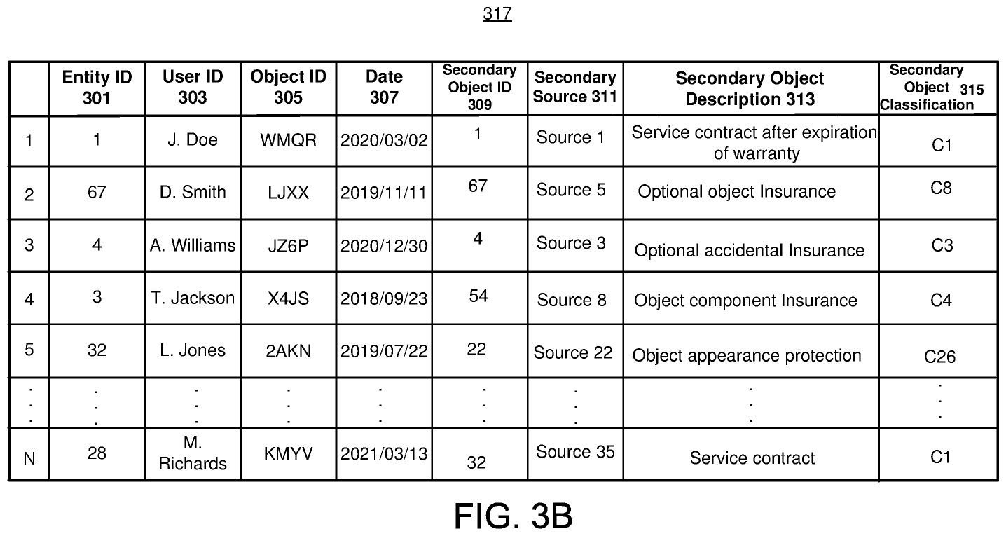

FIG. 3A illustrates an example set 300 of a plurality of historical acquisition entries of primary objects and secondary objects from different entities. The example set 300 includes N historical acquisitions that are stored in the acquisition database 201. As shown in FIG. 3A, each acquisition entry includes a plurality of entry attributes. The attributes of each historical acquisition entry include an identifier 301 of the entity 101 associated with the user acquisition, an identifier 303 of the user associated with the user acquisition (e.g., a first and last name of the user), the entity's identifier 305 of the primary object being acquired by the user (e.g., a vehicle identification number), a date of acquisition of the primary object and the secondary object, an identifier 311 of the secondary object source 111 that provided the secondary object to the entity, the secondary object source's internal identifier 311 for the secondary object being acquired by the user in addition to the primary object, and a description 313 of the secondary object.

Note that in other embodiments, the attributes may include other attributes than shown in FIG. 3A. For example, each acquisition entry may also include attributes of the primary object itself. In the example where the primary object is an automobile, the attributes of the primary object may include a make of the automobile, a model of the automobile, a year of the automobile, a type of purchase of the automobile (e.g., cash sale, finance sale, lease, etc.), a cost of the automobile, and a zip code of the user acquiring the automobile.

Referring back to FIG. 2, the rule database 203 stores a plurality of rules for classifying the secondary objects provided by the different secondary object sources 111 into one or more predetermined secondary object classifications from a plurality of secondary object classifications. In one embodiment, the predetermined secondary object classifications are fixed categories of secondary objects commonly provided by different entities 111 in a given industry (e.g., automobile industry). The predetermined secondary object classifications may be determined by experts of the industry, for example. As mentioned previously, although different secondary object sources 111 may provide the same type secondary object (e.g., secondary object source 111A and secondary object source 111B both provide their respective extended warranty), the different secondary object sources have their own unique internal identifier for the secondary object. The rules stored in the rule database 203 are used by the management system 103 to standardize the identifiers for the secondary objects across the different secondary object sources.

In one embodiment, the rule database 203 includes a plurality of different types of rules. In one embodiment, the rule database 203 includes mapping rules. Each mapping rule may correspond to an associated secondary object provided by one of the plurality of secondary object sources 111. Each mapping rule may specify the secondary object source 111's internal identifier for the secondary object associated with the mapping rule and one or more predetermined secondary object classifications that map to the internal identifier of the secondary object.

In one embodiment, the rule database also includes keyword based rules. Each keyword based rule specifies one or more keywords and indicates one or more predetermined secondary object classifications that map to the one or more keywords of the rule.

The training database 205 stores training data for training the prediction module 211 to predict likelihoods of selection of each of the one or more predetermined secondary object classifications. In one embodiment, the training data is training data generated by the training data generation module 207 as further described below.

The training data generation module 207 generates training data used to train the prediction module 211 which is a machine learning model. The training data generation module 207 generates training data based on the plurality of historical acquisition entries stored in the acquisition database 201. The historical acquisition entries are used to generate the training data since the entries are representative of secondary objects that are acquired by users in conjunction with primary objects.

In one embodiment, the training data generation module 207 generates the training data by classifying the historical acquisition entries with one or more predetermined secondary object classifications. As mentioned above, the predetermined secondary object classifications are fixed categories of secondary objects that are used to classify the secondary objects provided to the different entities 101 from the various secondary object sources 111. By classifying the historical user acquisition entries from multiple entities 101 with the predetermined secondary object classifications, the training data generation module 207 standardizes the identifiers of the secondary objects that are included in the historical user acquisition entries.

In one embodiment, the training data generation module 207 generates the training data using the rules stored in the rule database 203. The training data generation module 207 applies the rules in the rule database 203 to each of the historical user acquisition entries to classify each entry with a predetermined secondary object classification.

As mentioned above, the rules include mapping rules where each mapping rule specifies a secondary object's internal identifier and one or more predetermined secondary object classifications that map to the internal identifier of the secondary object. In one embodiment, the training data generation module 207 parses each historical acquisition entry to identify the identifier of the secondary object indicated in the historical acquisition entry. The training data generation module 207 compares the identifier of the secondary object to each of the mapping rules to identify a mapping rule having an identifier that matches the identifier of the secondary object indicated in the historical acquisition entry. Responsive to a match, the training data generation module 207 assigns the one or more predetermined secondary object classifications from the matching mapping rule to the historical acquisition entry.

As mentioned above, the rules also include keyword based rules where each keyword based rule specifies one or more keywords and indicates one or more predetermined secondary object classifications that map to the one or more keywords of the rule. In one embodiment, the training data generation module 207 parses each historical acquisition entry to identify keywords associated with the secondary object indicated in the historical acquisition entry. For example, the training data generation module 207 parses the description of the secondary object included in each historical acquisition entry to identify one or more keywords of the secondary object. The training data generation module 207 compares the keywords of the secondary object to each of the keyword based rules to identify a keyword based rule having a keyword that matches the one or more keywords of the secondary object indicated in the historical acquisition entry. Responsive to a match, the training data generation module 207 assigns the one or more predetermined secondary object classifications from the matching keyword based rule to the historical acquisition entry.

FIG. 3B illustrates an example of training data 317 generated by the training data generation module 207. The training data 317 includes the plurality of historical acquisition entries of primary objects and secondary objects described with respect to FIG. 3A. However, each of the plurality of historical user acquisition entries are now classified with one or more predetermined secondary object classifications 315. As shown in FIG. 3B, each entry is assigned a predetermined secondary object classification 315. In the example shown in FIG. 3B, entries “1” and “n” are associated with different secondary objects provided by different secondary object sources 311. However, the training data generation module 207 assigned the same secondary object classification “Cl” to both entries “1” and “n” signifying that the same type of secondary object was acquired in the acquisition described by entries “1” and “n”.

Referring back to FIG. 2, the prediction training module 209 trains the prediction module 211 to predict likelihoods of users selecting secondary objects for acquisition in addition to a primary object where the secondary objects are represented by the predetermined secondary object classifications. The prediction training module 209 trains the machine learned model of the prediction module 211 using the generated training data stored in the training database 205.

In one embodiment, the prediction training module 209 accesses the training data and extracts features from the plurality of historical acquisition entries included in the training data that are used to train the prediction module 211. The features extracted by the prediction training module 209 serve as descriptive quantitative representations of the historical acquisition entries for use in training the prediction module 211. For each historical user acquisition entry, the prediction training module 209 extracts a plurality of features. Generally, the features include the predetermined secondary object classification assigned to the entry and features of the primary object described by the entry. Thus, the extracted features for each entry signifies the relationship between the primary object and the secondary object since. The relationship may be used as a heuristic to predict the likelihood that a user may select a secondary object when acquiring a primary object since such an acquisition was previously performed.

The features of the primary object describe attributes of the primary object. In an example where the primary object is an automobile, the features of the automobile may include a make of the automobile, a model of the automobile, a year of the automobile, a type of acquisition of the automobile such as lease, finance, or cash payment, a cost of the automobile, and residence information associated with the user that acquired the automobile. The combination of the various features extracted from the historical user acquisition entries serve as feature vectors that characterize the historical user acquisition entries.

In one embodiment, the prediction module 211 is a machine-learned model. In one embodiment, the prediction training module 209 trains the prediction module 211 using the Smart Adaptive Recommendations (SAR) algorithm. However, the prediction training module 209 may train the prediction module 211 using any other recommendation algorithm including but not limited to collaborative filtering, factorization machines, neutral networks, support vectors, or logistic regression, etc. To train the prediction module 211, the prediction training module 209 applies the feature vectors that characterize the historical acquisition entries included in the training data as an input to the prediction module 211. The prediction training module 209 trains the prediction module 211 to learn a set of weights on features of the training data so that the prediction module 211 can generate for each of the plurality of predetermined secondary object classifications a predicted likelihood of selection a secondary object associated with the predetermined secondary object classification.

In one embodiment, rather than training the prediction module 211 with all of the training data at once, the prediction training module 209 divides the training data in the training database 205 into a plurality of training datasets based on time. Each of the plurality of training datasets is associated with a distinct time interval. That is, each training data set includes a subset of the plurality of historical user acquisition entries that have each been classified with a predetermined secondary object classification where the subset includes entries that describe acquisitions of the primary and secondary objects that occurred within the time interval of the training data set. In one embodiment, each training data set is associated with a different 3-month interval. However, different time intervals may be used.

The prediction training module 209 may first train the prediction module 211 using one of the training data sets. Once the initial training of the prediction module 211 using the a first one of the training data sets is complete, the prediction training module 209 may validate the accuracy of the trained prediction module 211. For example, the prediction training module 209 may re-apply the first training data set to the trained prediction module 211 (e.g., to the machine-learned SAR model) by applying the attributes of the primary object of each entry in the first training data set to the trained prediction module 211. Alternatively, the prediction training module 209 may apply a validation dataset to the trained prediction module 211 to test the accuracy of the trained prediction module 211 where the validation dataset is distinct from the training data. The validation data set includes historical acquisition entries where each acquisition entries is indicative of a primary object and one or more secondary objects that were acquired with the primary object.

Responsive to receiving a historical user acquisition entry from either the first training data set or the validation data set, the prediction module 211 outputs for each of the plurality of predetermined secondary object classifications a predicted likelihood (e.g., a percentage) that a user will acquire a secondary object associated with the classification in addition to the primary object specified in the entry. Given that each historical acquisition entry from the first training data set or validation data set includes the secondary object that was acquired along with the primary object, the prediction training module 209 can compare the predictions output by the prediction module 211 to the secondary object that was acquired with the primary object of each entry. The prediction training module 209 determines whether the prediction module 211 accurately predicted the predetermined secondary object classification that is associated with the secondary object specified in the entry based on the comparison.

The prediction training module 209 may update the prediction module 211 (e.g., the machine-learned SAR model) if the prediction training module 209 determines that the prediction module 211 did not accurately predict the correct predetermined secondary object classifications that corresponds to the secondary objects specified in the historical user acquisition entries of the first training data set with a threshold accuracy (e.g., 90% accurate). The prediction training module 209 may update the prediction module 211 by adjusting the weights of the features in the machine-learned SAR model. The prediction training module 209 may iteratively update the prediction module 211 until the prediction module 211 can make predictions with the threshold accuracy (e.g., 90% accuracy). Once the prediction training module 209 has trained the prediction module 211 to have the threshold accuracy using the first training data set, the prediction training module 209 repeats the training process for each of the plurality of training data sets. For example, the training process is repeated using a second training data set from the plurality of training data sets that is associated with a time interval after the time interval corresponding to the first training data set. After the prediction module 211 is trained to make predictions with the threshold accuracy using all of the plurality of training data sets, the prediction module 211 is considered trained.

In one embodiment, the prediction training module 209 may periodically retrain the prediction module 211 (e.g., the machine-learned SAR model) using more recent secondary object acquisition entries from different entities 101. By periodically retraining the prediction module 211, the prediction training module 209 can improve the prediction capabilities of the prediction module 211. In one embodiment, the prediction training module 209 retrains the prediction module 211 after a threshold amount of time has elapsed since the last training. For example, the prediction training module 209 retrains the prediction module 211 every 60 days. Alternatively, the prediction training module 209 retrains the prediction module 211 after a threshold amount of new secondary object acquisition entries are stored in the acquisition database 201 (e.g., one thousand new secondary object acquisitions).

As mentioned previously, the prediction module 211 is a trained machine learned model that predicts for each of the predetermined secondary object classifications a likelihood of selection of a secondary object associated with the classification. The prediction module 211 receives a request for a prediction of secondary objects for a primary object. The request may be received from an entity device 107. In one embodiment, the request is received by the prediction module 211 from the entity device 107 of an entity 101 responsive to a primary object being acquired from the entity. For example, a representative of the entity 101 may request a prediction from the prediction module 211 during a sale of an automobile at the entity 101. Alternative, the request may be received from a client device 109 (e.g., a customer of an entity).

In one embodiment, the request includes attributes of the primary object being acquired from the entity 101. As mentioned above, in an example where the primary object is an automobile, the attributes of the automobile may include a make of the automobile, a model of the automobile, a year of the automobile, a type of acquisition of the automobile such as lease, finance, or cash payment, a cost of the automobile, and residence information associated with the user that acquired the automobile. The prediction module 211 extracts from the request the attributes of the primary object for input.

The extracted attributes of the primary object are applied to the prediction module 211 and the prediction module 211 outputs for each predetermined secondary object classification a predicted likelihood that the secondary object corresponding to the predetermined secondary object classification will be selected by the user that is acquiring the primary object. In one embodiment, the likelihood is a value between 0 and 1. Thus, the prediction module 211 outputs a plurality of predicted likelihoods each prediction corresponds to one of the plurality of predetermined secondary object classifications.

The recommendation module 213 generates recommendations of secondary objects based on predictions made by the prediction module 211. The recommendation module 213 receives the predicted likelihoods for the plurality of predetermined secondary object classifications determined by the prediction module 111. In one embodiment, the recommendation module 213 ranks the plurality of predetermined secondary object classifications, and selects the highest ranked secondary object classifications output by the prediction module 213. For example, the recommendation module 213 selects the top 5 secondary object classifications output by the prediction module 213.

Generally, each entity 101 has preferred secondary object source 111 for secondary objects provided by the entity 101. In one embodiment, the management system 103 includes a list preferred secondary object sources 111 for each entity 101. For example, management system 103 may include a list of secondary object sources for entity 101A that specifies both secondary object source 111A and secondary object source 111B as the preferred secondary object sources for entity 101A whereas a list of secondary object sources for entity 101B may specify secondary object source 111B as the preferred secondary object source for entity 101B, but not secondary object source 111B.

The recommendation module 213 accesses for the entity 101 involved in the acquisition described in the request, the entity's preferred list of secondary object sources. For each of the highest ranked secondary object classifications (e.g., the top 5), the recommendation module 213 determines secondary objects provided by secondary object sources from the entity's list that correspond to the highest ranked secondary object classifications. The recommendation module 213 generates a recommendation of secondary objects to recommend for acquisition along with the primary object based on the determined secondary objects.

In one embodiment, the recommendation module 213 transmits the recommendation to the entity device 107 that transmitted the request for the prediction. The user acquiring the primary object may review the recommendation via the entity device 107. In another embodiment, the recommendation module 213 transmits the recommendation to both the entity device 107 that transmitted the request for the prediction and to the client device 109 of the user acquiring the primary object.

In one embodiment, the recommendation generated by the recommendation module 213 includes a statistical component related to the secondary objects included in the recommendation. In one embodiment, the statistical component for each secondary object included in the recommendation describes a percentage of other users who acquired the secondary object along with the primary object to further validate the recommendation. Considering the example where the primary object is a vehicle and a secondary object included in the recommendation is a GAP insurance, the recommendation may indicate that 50% of users who have acquired a similar vehicle on loan has opted to acquire the GAP insurance.

In one embodiment, the questionnaire module 215 generates a questionnaire regarding predetermined secondary object classifications of interest to clients of entities 101. The questionnaire requests for each client to provide the attributes of the client's primary object as described above, in addition to feedback regarding which of the plurality of predetermined secondary object classifications are of interest to the client. The questionnaire module 215 may receive from one or more of the clients answers to the questions in the questionnaire.

In one embodiment, the answers to the questions in the questionnaire are stored as training data in the training database 205. The prediction training module 209 may use the answers to the questions to re-train the prediction module 211 thereby improving prediction accuracy of the prediction module 211.

### Training Process

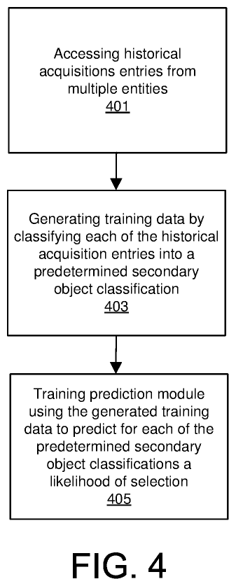

FIG. 4 is a diagram illustrating a process of the management system 103 for training the prediction module 211 according to one embodiment. Note that in other embodiments, other steps may be performed.

In one embodiment, the management system 103 accesses 401 historical acquisition entries from multiple entities 101. Each historical acquisition entry may specify one or more secondary objects that were acquired with a primary object by a user from a particular entity. The management system 103 generates 403 training data based on the historical acquisition entries.

In one embodiment, the management system 103 generates the training data by classifying each of the historical acquisition entries with a predetermined secondary object classification from a plurality of different predetermined secondary object classifications. By assigning the predetermined secondary object classifications to the historical acquisition entries, the management system 101 standardizes the secondary object identifiers included in the entries since the secondary objects may be provided from different secondary object sources 111.

The management system 103 trains 405 the prediction module 211 using the generated training data. The prediction module 211 is trained to predict for each of the predetermined secondary object classifications a likelihood of section of a secondary object associated with the predetermined secondary object classification.

### Recommendation Process

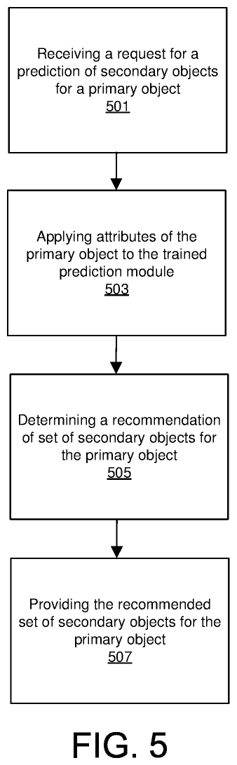

FIG. 5 is a diagram illustrating a process of the management system 103 for generating a recommendation of secondary objects according to one embodiment. Note that in other embodiments, other steps may be performed.

In one embodiment, the management system 103 receives 501 a request for a prediction of secondary objects for a primary object. The request may be received from an entity device 107 of an entity 101 involved in a user acquisition of the primary object provided by the entity 101. In one embodiment, the request includes attributes of the primary object.

The management system 103 applies 503 the attributes of the primary object to the trained prediction module 211. The prediction module 211 outputs for each of the plurality of predetermined secondary object classifications a predicted likelihood of user selection of a secondary object corresponding to the predetermined secondary object classification. The management system 103 determines 505 a recommendation of a set of secondary objects for the primary object based on the predictions. The management system 103 provides 507 the recommendation for the primary object. The recommendation may be provided to the entity device 107 that transmitted the request. Alternatively, or in addition, the recommendation may be provided to the client device 109 of the user acquiring the primary object.

### Hardware Components

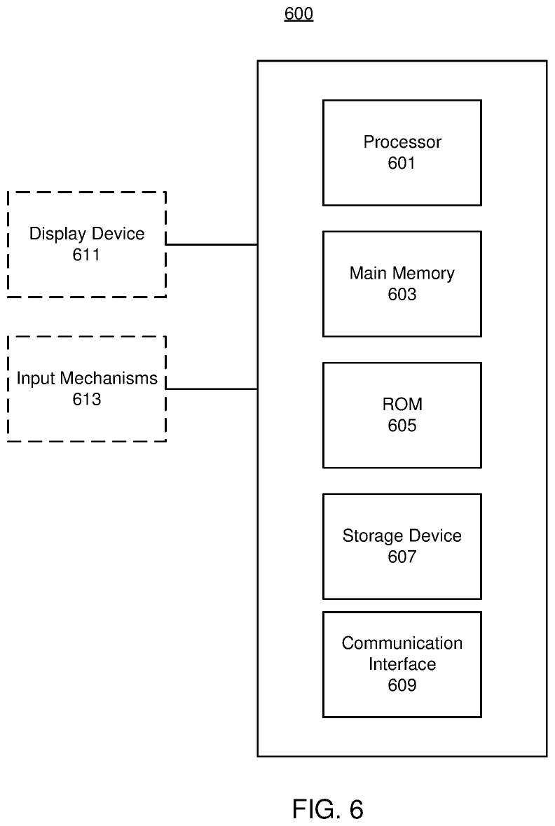

FIG. 6 is a diagram illustrating a computer system 600 upon which embodiments described herein may be implemented within the management system 103, entity devices 107, client devices 109, and secondary object sources 111. For example, the management system 103, entity devices 107, client devices 109, and secondary source 111 may each be implemented using a computer system such as described by FIG. 6. The management system 103 may also be implemented using a combination of multiple computer systems as described by FIG. 6.

In one implementation, the management system 103, entity devices 107, client devices 109, and secondary object sources each include processing resources 601, main memory 603, read only memory (ROM) 605, storage device 607, and a communication interface 609. The management system 103, entity devices 107, client devices 109, and secondary object sources 111 each include at least one processor 601 for processing information and a main memory 603, such as a random access memory (RAM) or other dynamic storage device, for storing information and instructions to be executed by the processor 601. In one embodiment, multiple processors are employed by the management system 103 to perform the techniques described above in order to improve efficiency of the management system 103 and reduce computation time when generating recommendations of secondary objects. Main memory 603 also may be used for storing temporary variables or other intermediate information during execution of instructions to be executed by processor 601. The management system 103, entity devices 107, client devices 109, and secondary object sources 111 may each also include ROM 605 or other static storage device for storing static information and instructions for processor 601. The storage device 607, such as a magnetic disk or optical disk or solid state memory device, is provided for storing information and instructions.

The communication interface 609 can enable each of management system 103, entity devices 107, client devices 109, and secondary object sources 111 to communicate with each other through use of a communication link (wireless or wireline). Each of management system 103, entity devices 107, client devices 109, and secondary object sources 111 can optionally include a display device 611, such as a cathode ray tube (CRT), an LCD monitor, an LED monitor, OLED monitor, a TFT display or a television set, for example, for displaying graphics and information to a user. An input mechanism 613, such as a keyboard that includes alphanumeric keys and other keys, can optionally be coupled to the computer system 600 for communicating information and command selections to processor 601. Other non-limiting, illustrative examples of input mechanisms 613 include a mouse, a trackball, touch-sensitive screen, or cursor direction keys for communicating direction information and command selections to processor 601 and for controlling cursor movement on display device 611.

Examples described herein are related to the use of the management system 103, entity devices 107, client devices 109, and secondary object source 111 for implementing the techniques described herein. According to one embodiment, those techniques are performed by each of the management system 103, entity devices 107, client devices 109, and secondary object sources 111 in response to processor 601 executing one or more sequences of one or more instructions contained in main memory 603. Such instructions may be read into main memory 603 from another machine-readable medium, such as storage device 607. Execution of the sequences of instructions contained in main memory 1103 causes processor 601 to perform the process steps described herein. In alternative implementations, hard-wired circuitry may be used in place of or in combination with software instructions to implement examples described herein. Thus, the examples described are not limited to any specific combination of hardware circuitry and software. Furthermore, it has also proven convenient at times, to refer to arrangements of operations as modules, without loss of generality. The described operations and their associated modules may be embodied in software, firmware, hardware, or any combinations thereof.

Reference in the specification to “one embodiment” or to “an embodiment” means that a particular feature, structure, or characteristic is included in at least one embodiment of the disclosure. The appearances of the phrase “in one embodiment” or “a preferred embodiment” in various places in the specification are not necessarily referring to the same embodiment.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects disclosed herein include process steps and instructions described herein in the form of a method. It should be noted that the process steps and instructions described herein can be embodied in software, firmware or hardware, and when embodied in software, can be downloaded to reside on and be operated from different platforms used by a variety of operating systems.

The embodiments discussed above also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The methods and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the embodiments are not described with reference to any particular programming language. It will be appreciated that a variety of programming languages may be used to implement the teachings described herein, and any references below to specific languages are provided for disclosure of enablement and best mode.

While the disclosure has been particularly shown and described with reference to a preferred embodiment and several alternate embodiments, it will be understood by persons skilled in the relevant art that various changes in form and details can be made therein without departing from the spirit and scope of the invention.

1. A computer-implemented method for generating secondary object recommendations for a primary object comprising:
accessing, by a management system of a plurality of different entities, a plurality of historical acquisition entries of the plurality of different entities, each of the plurality of historical acquisition entries describing a user purchase of both a primary object and a secondary object for the primary object from one of the plurality of different entities, wherein secondary objects described by the plurality of historical acquisition entities are provided to the plurality of different entities by a plurality of different secondary object sources, each of the plurality of historical acquisition entries including a secondary object identifier for the secondary object described by the historical acquisition entry, the secondary object identifier unique to a secondary object source from the plurality of different secondary object sources that provided the secondary object and the secondary object identifier uniquely identifying the secondary object from amongst other secondary objects provided by the secondary object source;
determining a plurality of predetermined secondary object classifications that describe a plurality of categories of secondary objects provided by the plurality of different entities;
generating, by the management system, training data by classifying each of the plurality of historical acquisition entries into at least one of the plurality of categories described by the plurality of predetermined secondary object classifications based at least on the secondary object identifier of the secondary object included in the historical acquisition entry, the classification of each of the plurality of historical acquisition entries into at least one of the plurality of categories standardizing secondary object identifiers included in the plurality of historical acquisition entries such that at least two of the plurality of historical acquisition entries are classified with a same predetermined secondary object classification from the plurality of predetermined secondary object classifications despite the two historical acquisition entries describing secondary objects having different secondary object identifiers;
training, by the management system, a machine learning model using the generated training data, the trained machine learning model configured to predict for each of the plurality of predetermined secondary object classifications a likelihood of selection of a secondary object corresponding to the predetermined secondary object classification;
receiving, by the management system, a request for recommended secondary objects for a primary object being purchased by a user from an entity from the plurality of different entities, the request received from an entity device of the entity and including attributes of the primary object being purchased from the entity;
applying, by the management system, the attributes of the primary object to the trained machine learning model responsive to the request, the trained machine learning model predicting for each of the plurality of predetermined secondary object classifications a likelihood of purchase by the user that is purchasing the primary object a secondary object corresponding to the predetermined component classification;
determining, by the management system, a recommended set of secondary objects for the primary object based on the predicted likelihoods of purchase for each of the plurality of predetermined secondary object classifications; and
providing, by the management system, the recommended set of secondary objects for the primary object to the entity device.

2. The computer-implemented method of claim 1, wherein each of the plurality of historical acquisition entries further includes a description of the secondary object.

3. The computer-implemented method of claim 1, wherein generating the training data by classifying each of the plurality of historical acquisition entries comprises:
accessing a plurality of mapping rules, each mapping rule mapping a secondary object identifier of a secondary object provided by one of the plurality of secondary object sources to a predetermined secondary object classification from the plurality of secondary object classifications;
comparing the secondary object identifier included in each of the plurality of historical acquisition entries to the plurality of mapping rules, the comparison resulting in a match between the secondary object identifier and a secondary object identifier included in at least one of the plurality of mapping rules; and
classifying each of the plurality of historical acquisition entries with the predetermined secondary object classification included in the mapping rule having the secondary object identifier that matches the secondary object identifier included in the historical acquisition entry.

4. The computer-implemented method of claim 2, wherein generating the training data by classifying each of the plurality of historical acquisition entries comprises:
accessing a plurality of keyword based rules, each keyword based rule mapping one or more keywords to a predetermined secondary object classification from the plurality of secondary object classifications;
comparing the description of the secondary object included in each of the plurality of historical acquisition entries to the plurality of keyword based rules, the comparison resulting in a match between at least one keyword included in the description and a keyword included in at least one of the plurality of keyword based rules; and
classifying each of the plurality of historical acquisition entries with the predetermined secondary object classification included in the keyword based rule having the keyword that matches the keyword included in the description of the secondary object.

5. The computer-implemented method of claim 1, wherein training the machine learning model comprises:
extracting features from each of the plurality of historical acquisition entries included in the training data, the extracted features including a predetermined secondary object classification assigned to the historical acquisition entry and features of the primary object described by the historical acquisition entry, wherein the machine learning model is trained using the extracted features

6. The computer-implemented method of claim 5, wherein the primary object described by the historical acquisition entry is an automobile and the extracted features of the automobile include a make of the automobile, a model of the automobile, a year of the automobile, a type of acquisition of the automobile, a cost of the automobile, and residence information of the user acquiring the automobile.

7. The computer-implemented method of claim 6, wherein the machine learning model is trained using a Smart Adaptive Recommendations (SAR) algorithm.

8. The computer-implemented method of claim 1, wherein training the machine learning model comprises:
dividing the training data into a plurality of training datasets based on time, each of the plurality of training datasets associated with a predetermined time interval and including a subset of the plurality of historical acquisition entries describing user acquisitions of primary objects and secondary objects that occurred within the predetermined time interval;
training the machine learning model using a first training dataset from the plurality of training data sets;
validating an accuracy of the trained machine learning model with respect to a threshold accuracy responsive to the training using the first training dataset; and
training the trained machine learning model using a second training dataset from the plurality of training data sets responsive to the accuracy being greater than the threshold accuracy.

9. The computer-implemented method of claim 1, wherein determining the recommended set of secondary objects for the primary object comprises:
identifying one or more secondary object sources from the plurality of different secondary object sources that are preferred by the entity that is providing the primary object being acquired by the user;
ranking the plurality of predetermined secondary object classifications based on the predicted likelihood for each of the plurality of predetermined secondary object classifications;
determining for at least a highest ranked predetermined secondary object classification from the ranked plurality of predetermined secondary object classifications, a secondary object provided by the one or more preferred secondary object sources that corresponds to the highest ranked predetermined secondary object classification; and
wherein the secondary object is at least one of a finance product or an insurance product for an automobile.

10. The computer-implemented method of claim 1, further comprising:
generating a questionnaire including a list of the plurality of predetermined secondary object classifications;
providing the questionnaire to a plurality of clients of the plurality of entities;
receiving feedback on the plurality of secondary object classifications from one or more of the plurality of clients; and
retraining the machine learned model based on the received feedback.

11. A non-transitory computer-readable storage medium storing executable computer program instructions for sharing documents for generating secondary object recommendations for a primary object, the instructions when executed by one or more computer processors cause the one or more computer processors to perform steps comprising:
accessing, by a management system of a plurality of different entities, a plurality of historical acquisition entries of the plurality of different entities, each of the plurality of historical acquisition entries describing a user purchase of both a primary object and a secondary object for the primary object from one of the plurality of different entities, wherein secondary objects described by the plurality of historical acquisition entities are provided to the plurality of different entities by a plurality of different secondary object sources, each of the plurality of historical acquisition entries including a secondary object identifier for the secondary object described by the historical acquisition entry, the secondary object identifier unique to a secondary object source from the plurality of different secondary object sources that provided the secondary object and the secondary object identifier uniquely identifying the secondary object from amongst other secondary objects provided by the secondary object source;
determining a plurality of predetermined secondary object classifications that describe a plurality of categories of secondary objects provided by the plurality of different entities;
generating, by the management system, training data by classifying each of the plurality of historical acquisition entries into at least one of the plurality of categories described by the plurality of predetermined secondary object classifications based at least on the secondary object identifier of the secondary object included in the historical acquisition entry, the classification of each of the plurality of historical acquisition entries into at least one of the plurality of categories standardizing secondary object identifiers included in the plurality of historical acquisition entries such that at least two of the plurality of historical acquisition entries are classified with a same predetermined secondary object classification from the plurality of predetermined secondary object classifications despite the two historical acquisition entries describing secondary objects having different secondary object identifiers;
training, by the management system, a machine learning model using the generated training data, the trained machine learning model configured to predict for each of the plurality of predetermined secondary object classifications a likelihood of selection of a secondary object corresponding to the predetermined secondary object classification;
receiving, by the management system, a request for recommended secondary objects for a primary object being purchased by a user from an entity from the plurality of different entities, the request received from an entity device of the entity and including attributes of the primary object being purchased from the entity;
applying, by the management system, the attributes of the primary object to the trained machine learning model responsive to the request, the trained machine learning model predicting for each of the plurality of predetermined secondary object classifications a likelihood of purchase by the user that is purchasing the primary object a secondary object corresponding to the predetermined component classification;
determining, by the management system, a recommended set of secondary objects for the primary object based on the predicted likelihoods of purchase for each of the plurality of predetermined secondary object classifications; and
providing, by the management system, the recommended set of secondary objects for the primary object to the entity device.

12. The non-transitory computer-readable storage medium of claim 11, wherein each of the plurality of historical acquisition entries further includes a description of the secondary object.

13. The non-transitory computer-readable storage medium of claim 11, wherein generating the training data by classifying each of the plurality of historical acquisition entries comprises:
accessing a plurality of mapping rules, each mapping rule mapping a secondary object identifier of a secondary object provided by one of the plurality of secondary object sources to a predetermined secondary object classification from the plurality of secondary object classifications;
comparing the secondary object identifier included in each of the plurality of historical acquisition entries to the plurality of mapping rules, the comparison resulting in a match between the secondary object identifier and a secondary object identifier included in at least one of the plurality of mapping rules; and
classifying each of the plurality of historical acquisition entries with the predetermined secondary object classification included in the mapping rule having the secondary object identifier that matches the secondary object identifier included in the historical acquisition entry.

14. The non-transitory computer-readable storage medium of claim 12, wherein generating the training data by classifying each of the plurality of historical acquisition entries comprises:
accessing a plurality of keyword based rules, each keyword based rule mapping one or more keywords to a predetermined secondary object classification from the plurality of secondary object classifications;
comparing the description of the secondary object included in each of the plurality of historical acquisition entries to the plurality of keyword based rules, the comparison resulting in a match between at least one keyword included in the description and a keyword included in at least one of the plurality of keyword based rules; and
classifying each of the plurality of historical acquisition entries with the predetermined secondary object classification included in the keyword based rule having the keyword that matches the keyword included in the description of the secondary object.

15. The non-transitory computer-readable storage medium of claim 11, wherein training the machine learning model comprises:
extracting features from each of the plurality of historical acquisition entries included in the training data, the extracted features including a predetermined secondary object classification assigned to the historical acquisition entry and features of the primary object described by the historical acquisition entry, wherein the machine learning model is trained using the extracted features,
wherein the primary object described by the historical acquisition entry is an automobile and the extracted features of the automobile include a make of the automobile, a model of the automobile, a year of the automobile, a type of acquisition of the automobile, a cost of the automobile, and residence information of the user acquiring the automobile.

16. The non-transitory computer-readable storage medium of claim 15, wherein the machine learning model is trained using Smart Adaptive Recommendations (SAR) algorithm.

17. The non-transitory computer-readable storage medium of claim 11, wherein training the machine learning model comprises:
dividing the training data into a plurality of training datasets based on time, each of the plurality of training datasets associated with a predetermined time interval and including a subset of the plurality of historical acquisition entries describing user acquisitions of primary objects and secondary objects that occurred within the predetermined time interval;
training the machine learning model using a first training dataset from the plurality of training data sets;
validating an accuracy of the trained machine learning model with respect to a threshold accuracy responsive to the training using the first training dataset; and
training the trained machine learning model using a second training dataset from the plurality of training data sets responsive to the accuracy being greater than the threshold accuracy.

18. The non-transitory computer-readable storage medium of claim 11, wherein determining the recommended set of secondary objects for the primary object comprises:
identifying one or more secondary object sources from the plurality of different secondary object sources that are preferred by the entity that is providing the primary object being acquired by the user;
ranking the plurality of predetermined secondary object classifications based on the predicted likelihood for each of the plurality of predetermined secondary object classifications;
determining for at least a highest ranked predetermined secondary object classification from the ranked plurality of predetermined secondary object classifications, a secondary object provided by the one or more preferred secondary object sources that corresponds to the highest ranked predetermined secondary object classification; and
wherein the secondary object is at least one of a finance product or an insurance product for an automobile.

19. The non-transitory computer-readable storage medium of claim 11, wherein the instructions when executed by one or more computer processors further cause the one or more computer processors to perform steps comprising:
generating a questionnaire including a list of the plurality of predetermined secondary object classifications;
providing the questionnaire to a plurality of clients of the plurality of entities;
receiving feedback on the plurality of secondary object classifications from one or more of the plurality of clients; and
retraining the machine learned model based on the received feedback.

20. A computer system for generating secondary object recommendations for a primary object comprising:
one or more computer processors;
a non-transitory computer-readable storage medium storing executable computer program instructions, the instructions when executed by the one or more computer processors cause the one or more computer processors to perform steps comprising:
accessing a plurality of historical acquisition entries of the plurality of different entities, each of the plurality of historical acquisition entries describing a user purchase of both a primary object and a secondary object for the primary object from one of the plurality of different entities, wherein secondary objects described by the plurality of historical acquisition entities are provided to the plurality of different entities by a plurality of different secondary object sources, each of the plurality of historical acquisition entries including a secondary object identifier for the secondary object described by the historical acquisition entry, the secondary object identifier unique to a secondary object source from the plurality of different secondary object sources that provided the secondary object and the secondary object identifier uniquely identifying the secondary object from amongst other secondary objects provided by the secondary object source;
determining a plurality of predetermined secondary object classifications that describe a plurality of categories of secondary objects provided by the plurality of different entities;
generating training data by classifying each of the plurality of historical acquisition entries into at least one of the plurality of categories described by the plurality of predetermined secondary object classifications based at least on the secondary object identifier of the secondary object included in the historical acquisition entry, the classification of each of the plurality of historical acquisition entries into at least one of the plurality of categories standardizing secondary object identifiers included in the plurality of historical acquisition entries such that at least two of the plurality of historical acquisition entries are classified with a same predetermined secondary object classification from the plurality of predetermined secondary object classifications despite the two historical acquisition entries describing secondary objects having different secondary object identifiers;
training a machine learning model using the generated training data, the trained machine learning model configured to predict for each of the plurality of predetermined secondary object classifications a likelihood of selection of a secondary object corresponding to the predetermined secondary object classification;
receiving a request for recommended secondary objects for a primary object being purchased by a user from an entity from the plurality of different entities, the request received from an entity device of the entity and including attributes of the primary object being purchased from the entity;
applying the attributes of the primary object to the trained machine learning model responsive to the request, the trained machine learning model predicting for each of the plurality of predetermined secondary object classifications a likelihood of purchase by the user that is purchasing the primary object a secondary object corresponding to the predetermined component classification;
determining a recommended set of secondary objects for the primary object based on the predicted likelihoods of purchase for each of the plurality of predetermined secondary object classifications; and
providing the recommended set of secondary objects for the primary object to the entity device.
